(19) United States
(12) Patent Application Publication
(10) Pub. No.: US 2012/0010033 A1
(43) Pub. Date: Jan. 12, 2012

(54) Tensioning Device with Pivotable Joint Connection

(75) Inventors: Bernhard Schachtner, Johanneskirchen (DE); Martin Bodensteiner, Muenchen (DE); Sebastian Hauke, Olching (DE)

(73) Assignee: IWIS MOTORSYSTEME GMBH & CO. KG, Muenchen (DE)

(21) Appl. No.: 12/914,910

(22) Filed: Oct. 28, 2010

(30) Foreign Application Priority Data
Nov. 20, 2009 (EP) 09014517.8

(51) Int. Cl. F16H 7/08

(52) U.S. Cl. 474/110

(57) ABSTRACT

A tensioning device for an endless drive is provided. The tensioning device comprises a tensioning lever and a tensioning piston. The tensioning lever comprises a connection socket, and the tensioning piston comprises a connection head. A pivotable joint connection is implemented between the tensioning lever and the tensioning piston by means of the connection head. The connection socket defines a reception opening, and at least certain areas of the connection head are, by means of the connection socket and at least one boundary area formed thereon, encompassed in the reception opening in such a way that the connection head is secured against separation from the connection socket in a direction opposite to the direction of operation of the tensioning piston.

### CROSS-REFERENCE TO RELATED APPLICATIONS

This application claims priority to foreign Patent Application EP 09 014 517.8, filed on Nov. 20, 2009, the disclosure of which is incorporated herein by reference in its entirety.

### FIELD OF THE INVENTION

The present invention relates to a tensioning device for an endless drive. More particularly, the present invention relates to a tensioning device for an endless drive comprising a tensioning lever and a tensioning piston.

### BACKGROUND OF THE INVENTION

Such tensioning devices are especially used in timing assemblies and/or auxiliaries drive assemblies of internal combustion engines. In timing assemblies, the movement of the crankshaft is transmitted to the camshaft by an endless drive. In the case of auxiliaries drive assemblies, the endless drive serves to drive the auxiliary units, i.e. for example, the electric generator, the air conditioning compressor, the water pump, the servo-steering mechanism, etc. In timing assemblies as well as in auxiliaries drive assemblies a belt or a chain can be used for this purpose. The tensioning device is used for keeping under tension the respective drive employed, whereby a uniform transmission of power will be guaranteed. In particular, a so-called knocking of the drive is prevented. This will provide a uniform drive and prevent damage being caused to the bearings of the cam shaft and of the auxiliary units. In addition, a correct tension will especially be necessary for timing assemblies in order to observe the precisely specified valve timing for the individual valves and guarantee perfect running of the engine. Moreover, force peaks occurring in a non-tensioned condition of the drive may lead to premature wear or tearing of the drive.

In connection with devices of the type in question it is known to configure such tensioning devices such that they consist of a tensioning lever and a tensioning element or tensioning piston. The tensioning element is attached to the tensioning lever by means of separate fastening elements. The fastening elements used for this purpose are normally screws or bolts, which establish a firm connection between the tensioning lever and the tensioning element. This is disadvantageous insofar as a separate fastening element is required for connecting the tensioning lever and the tensioning piston. This necessitates an additional mounting step and leads, moreover, to a higher investment in stock-keeping and logistics.

### SUMMARY OF THE INVENTION

One aspect of the present invention provides a tensioning device which eliminates the known drawbacks of the prior art and which especially simplifies the mounting of the tensioning device.

A tensioning device for an endless drive of the type in question is so conceived that the tensioning lever comprises a connection socket, that the tensioning piston comprises a connection head, that a pivotable joint connection is implemented between the tensioning lever and the tensioning piston by means of the connection head, that the connection socket defines a reception opening, and that, by means of the connection socket and at least one boundary area formed thereon, the connection head is, at least in certain areas thereof, encompassed in the reception opening in such a way that the connection head is secured against separation from the connection socket in a direction opposite to the direction of operation of the tensioning piston. The tensioning lever with the connection socket and the reception opening defined thereby is configured for accommodating the connection head. When the connection head has been inserted in the reception opening, the boundary area of the reception opening and of the connection socket, respectively, encloses the connection head at least in certain areas thereof so that a removal of the connection head from the reception opening is not possible without an application of force. On the basis of this structural design, the tensioning device according to embodiments of the present invention can be mounted rapidly and at low cost. In particular, no additional mounting elements are required for fixing the tensioning lever to the tensioning piston. The connection is established by means of positive locking, and, consequently, additional mounting elements, such as bolts, can be dispensed with. Mounting is carried out without making use of any tools, and the technician can immediately discern the correct mounting position and also check the mode of operation. The normally necessary assembly stations can be dispensed with, whereby the operating procedures will be simplified from the logistic point of view.

One possibility of further developing the tensioning device is that the direction of operation of the tensioning piston extends along a longitudinal axis of the tensioning piston, and that the boundary area reduces the width of a cross-section of the reception opening along the longitudinal axis and defines an undercut in which the connection head is accommodated, at least in certain areas thereof. By means of the undercut defined in the reception opening, the connection head positioned in said reception opening can be held reliably. This is accomplished in an advantageous manner especially when the boundary area or boundary areas are arranged symmetrically with respect to the longitudinal axis of the tensioning piston. The boundary areas reduce the width of the opening through which the connection head is connected with the tensioning piston. A separation of the connection head from the tensioning piston is therefore not possible in the case of the forces and directions of forces which normally occur during operation.

Another advantage is accomplished, when the tensioning device is configured such that the tensioning lever is provided with fastening means for pivotable fastening to a mounting structure. The tensioning forces of the tensioning piston can thus be transmitted by means of the tensioning lever. Making use of the leverage forces, it is thus possible to fix the tensioning device also at disadvantageous positions. In addition, the tensioning piston can be provided with a lower tensioning force, since said tensioning force will be increased by the leverage. The mounting structure used may e.g. be an engine element or the engine block.

In addition, the tensioning device can be so conceived that the joint connection comprises a joint cap and a joint bearing with a cross-section that is substantially circular in the direction of the longitudinal axis of the tensioning piston. The pivotable joint connection is thus realized by means of the joint cap and the joint bearing. To this end, the joint cap is pivotably attached to the joint bearing. For reducing the necessary joint forces and for accomplishing a kinematically uniform pivoting movement, the joint bearing preferably has a cross-section which is substantially circular in the direction of the longitudinal axis of the tensioning piston. Accordingly, the joint cap preferably has a shape which is essentially adapted to the circular cross-section.

The tensioning piston may also comprises a spring which rests on the joint cap with one end portion thereof. In this case, the tensioning piston and the connection head can be implemented as a structural unit that can be transported in a fully assembled condition. This will facilitate transport and mounting. For fully mounting the tensioning device, it will then suffice to attach the tensioning lever to the connection head. This may, for example, be done only immediately prior to installing the tensioning device on or in the engine. In addition, due to the fact that the spring rests on the joint cap, it will be able to absorb the forces occurring when the connection head is being pivoted and to return the connection head to its original position.

Another advantage is accomplished when the reception opening encompasses the substantially circular cross-section of the joint bearing up to and beyond an equatorial plane. The reception opening encompasses the circular cross-section of the joint bearing at the area having the largest or broadest cross-section and also beyond said area. It follows that the connection socket encompasses the substantially circular cross-section at the point where it has the largest dimensions and also beyond said point up to a position where the cross-section already narrows. This has the effect that the connection head is reliably held in the reception opening and can only be removed from the connection socket by an application of force.

Furthermore, the tensioning device can be so conceived that the connection head is inserted in the reception opening in the direction of the longitudinal axis of the tensioning piston. The connection head is here pushed or pressed into the connection socket, i.e. into the reception opening. Due to the insertion of the connection head in the direction of the longitudinal axis of the tensioning piston, said connection head is compressed, whereby the force applied will be increased. In addition, the insertion of the connection head in the direction of the longitudinal axis of the tensioning element will reduce the risk of damage being caused to the tensioning piston during insertion by transverse forces occurring.

It is also imaginable that, at least in the area of the connection socket, the tensioning lever is elastically deformable. The connection head can thus be inserted more easily into the connection socket.

Likewise, it is possible that the connection socket is provided with at least one transverse opening in one side of the tensioning lever, so that the connection head can be inserted from the side. Instead of inserting the connection head axially in the direction of the longitudinal axis, it is thus possible to insert the connection head into the connection socket transversely, i.e. preferably at right angles to the longitudinal axis.

The tensioning device may also be so conceived that the connection head has a dovetail-shaped cross-section in the direction of the longitudinal axis of the tensioning piston. The connection head having the dovetail-shaped cross-section is attached to the tensioning piston in such a way that the area having the broader cross-section is farther away from the tensioning piston, whereas the area having the narrower cross-section is located closer to the tensioning piston. When the connection head having the dovetail-shaped cross-section has been inserted into the complementary reception opening, the aperture of the reception opening will narrow in the direction of the tensioning piston, whereby the broader end of the connection head will fixedly be held in the reception opening and the connection socket, respectively.

Alternatively, the connection head has an L-shaped cross-section in the direction of the longitudinal axis of the tensioning piston, a tongue defined through said L-shaped cross-section engaging the reception opening, at least in certain areas thereof, and engaging behind the boundary area. The L-shaped tongue can be produced easily with the known manufacturing methods, and it is also easily possible to design a reception opening which is adapted to the L-shaped tongue. Hence, a possibility of easily producing and mounting the tensioning device is obtained. The reception opening defines an undercut, and the tongue having the L-shaped cross-section engages said undercut and is retained therein.

According to another alternative, a captive fastener may be positioned between the tensioning lever and the connection head, said captive fastener causing the tensioning lever and the connection head to be in a biased condition. The captive fastener can be configured as a leaf or disk spring. Undesirable movements between the tensioning lever and the connection head, which may be caused during operation, e.g. by vibrations, are avoided in this way.

The tensioning device may also be configured such that the captive fastener is formed integrally with the connection head. By means of this integration of functions, the assembly of the tensioning device can be simplified still further.

According to another embodiment of the present invention, the tensioning device can additionally have a second joint bearing, which is formed on an end portion of the tensioning piston facing away from the connection head. By means of this second joint bearing, the tensioning device can easily be secured to an engine element, by way of example.

The tensioning device may also be so conceived that the second joint bearing is configured such that, together with a mating joint component, it defines a pivotable joint. This provides the possibility of implementing the tensioning device as a pivotable component with the second, mating joint component. The possibilities of use of the tensioning device will be increased in this way.

Furthermore, another embodiment of the present invention comprises a traction drive for an internal combustion engine, comprising an endless drive, at least two drive wheels arranged in an area enclosed by the endless drive, and one of the above-presented tensioning devices and their alternative embodiments.

### BRIEF DESCRIPTION OF THE DRAWINGS

In the following, embodiments of the present invention will be described in more detail which reference to the drawings, in which:

FIG. 1 shows a schematic sectional view of a tensioning device according to an embodiment of the present invention;

FIG. 2 shows an enlarged representation of the area of the schematic sectional view marked in FIG. 1;

FIG. 3 shows a schematic representation of the tensioning lever according to FIG. 1;

FIG. 4 shows a schematic sectional view of a second embodiment of the connection area between the tensioning lever and the tensioning piston;

FIG. 5 shows a further embodiment in a schematic sectional view through the connection area between the tensioning lever and the tensioning piston; and

FIG. 6 shows a further embodiment in a schematic sectional view through the connection area between the tensioning lever and the tensioning piston.

### DETAILED DESCRIPTION

The tensioning device according to one embodiment of the present invention comprises a tensioning lever 1 and a tensioning element implemented as a tensioning piston 2. The tensioning piston 2 has a connection head 5 comprising a joint bearing 3 and a joint cap 25 defining together a joint connection.

The tensioning lever 1 comprises a wing-like portion having provided therein a first opening 6 and a second opening 7 which is spaced apart from said first opening 6. The first and second openings 6, 7 extend preferably fully through the tensioning lever 1 and may, for example, be configured as a bore. Said first and second openings 6, 7 serve as fastening means. The tensioning lever 1 has provided thereon a connection socket 24 defining a reception opening 4. The connection socket is provided with at least one boundary area 35 which is defined thereon. In the embodiment shown, the connection socket 24 is formed integrally with the tensioning lever 1. The connection socket 24 may, however, also be implemented by a separate element which is attached to the tensioning lever. The tensioning lever 1 is provided with a reception opening 4 defined by the connection socket 24.

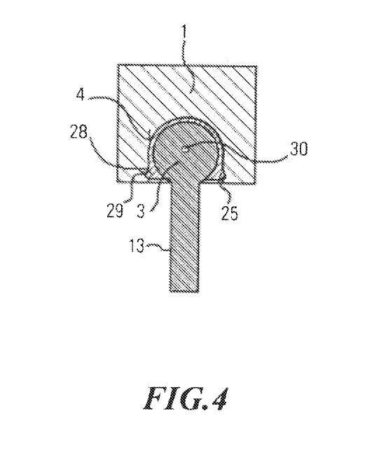

In the embodiment shown (FIG. 3), the reception opening 4 is substantially circular or has at least the shape of a circular arc on its outer circumference and it is open towards one side of the tensioning lever 1. The reception opening 4 has a first opening width 26 and a second opening width 27. The first opening width 26 is larger, i.e. broader, than the second opening width 27. When seen along the longitudinal axis 22, the first opening width 26 is farther away from the tensioning piston 2 than the second opening width 27. The width is here defined as the opening width of the reception opening 4 transversely to a pivot axis 30 about which pivoting takes place in the connection head 5. It follows that the reception opening 4 has a variable opening width transversely to the pivot axis 30. The narrowing of the reception opening 4, which is defined by the smaller opening width of the second opening width 27, is caused by at least one boundary area 35 delimiting the reception opening 4. The narrowing takes place symmetrically with the longitudinal axis 22. By means of said narrowing, an undercut is formed in the reception opening 4. In a future case of use, a tensioning pulley, which comes into contact with a drive, can be fixed to the tensioning lever 1 at the second opening 7. The first opening 6 serves to fix the tensioning lever 1 to a mounting structure and the engine block, respectively.

The tensioning piston 2 comprises a damper arrangement 9 as well as a spring 10. The spring is implemented as a cylindrical compression spring and extends around the damper arrangement 9. The damper arrangement 9 includes a damper housing 11 comprising a preferably cylindrical internal space. Within the damper housing 11 a damper plate 12 as well as a damper piston 13 are positioned, said damper piston 13 extending through a housing passage 14 from the interior of the housing to the outside thereof. The damper 8 plate 12 divides the area enclosed by the damper housing 11 into a first damping chamber 15 and a second damping chamber 16. The first and second damping chambers 15, 16 are filled with a non-compressible fluid. Passage openings for the damping fluid are provided on or in the damper plate, said passage openings allowing a predetermined fluid flow from the first damping chamber 15 into the second damping chamber 16, and vice versa. The damper piston 13 is fixed to the damper plate 12. Alternatively, also other damper designs may be used, such as frictional dampers. The spring 10 may also be arranged in a mode differing from the above-mentioned one. The spring 10 may also be installed in an internal space of the damper and act directly on the damper piston 13.

A first end portion 17 of the tensioning piston 2 has formed thereon a spring carrier 18, which is provided in an outer area of said first end portion 17 and on which the spring 10 rests. An additional spring carrier 20 is provided in the vicinity of the second end portion 19 of the tensioning piston 2, which is disposed in opposed relationship with the first end portion 17 thereof, the second end portion of the spring 10 resting on said additional spring carrier 20. The first end portion 17 of the tensioning piston 2 has additionally provided thereon a fastening element 21, which can be used for fixing the tensioning piston 2 to an element of the engine. The provision of the second spring carrier 20 can, however, also be dispensed with. The spring 10 will then rest on the tensioning lever 1.

The damper piston 13 extends through the first damping chamber 15, and making use of the sealed housing passage 14 through the damper housing 11 in the direction of the second end portion 19 of the tensioning piston 2. In the embodiment shown, the tensioning piston 2 has a longitudinal axis 22 which extends through the damper piston 13 in said embodiment. Hence, the longitudinal axis 22 extends from the fastening element 21 from the first end portion 17 through the first and second damping chambers 15, 16 to the second end portion 19. The direction of operation of the tensioning piston 2 corresponds to the direction of force of the compression spring 10, i.e., the direction of the longitudinal axis 22. When the tensioning piston is fixed to the lower fastening element 21, the resultant direction of operation of the tensioning piston will thus cause a movement of the damper piston 13 and of the connection head 5 in the direction of the tensioning lever 1.

At the piston end 23 of the damper piston 13, the connection head 5 is provided. The connection head 5 can be connected to the damper piston 13 in one piece or it can be formed integrally therewith. The connection head 5 may, however, also be connected to the damper piston 13 in some other way. In the embodiment shown in FIG. 1, the connection head 5 is provided with a joint bearing 3 having a circular or cylindrical cross-section. A joint cap 25 extends around the joint bearing 3. The joint cap 25 encloses the joint head essentially completely and has a substantially identical inner contour corresponding essentially to the outer contour of the joint bearing 3. The joint cap 25 is pivotably supported on the joint bearing 3, whereby a pivotable joint connection is obtained. Alternatively, it is also possible to implement the connection head 5 only as a joint bearing 3 having no joint cap 25 attached thereto. In this case, the joint bearing 3 is in direct contact with the reception opening 4 and is adapted to be pivoted relative thereto. In the embodiment shown, the second spring carrier 20 is attached to the connection head 5 or formed integrally therewith.

The connection head 5 is inserted in the reception opening 4 of the tensioning lever 1. The joint cap 25 has, for example, a bell-shaped or circular-arc-shaped outer contour. The connection socket 24 has a inner contour that is substantially identical with the outer contour of the joint cap 25. The tensioning lever 1 encloses the connection head 5, which is inserted in the reception opening 4, such that the boundary area 35 engages behind at least one area of the connection head 5, i.e., the reception opening 4 has a first opening width 26 in one area and a second opening width 27 in a second area, viz. on the boundary area 35, said second opening width 27 being smaller than said first opening width 26. It follows that, when the connection head 5 has been inserted in the reception opening 4, the boundary area 35 will encompass it or engage behind it, so that said connection head 5 cannot release or separate from the tensioning lever 1 of its own accord.

The connection head 5 may be configured as a spherical or as a cylindrical component, i.e., the ball head 5 will have, for example, the shape of a spherical sector or a spherical segment, which is secured in position on the damper piston 13. It follows that, when the reception opening 4 is shaped complementarily to the connection head 5 having the shape of a spherical sector, a large number of pivot axes will be obtained, about which the tensioning lever 1 can be pivoted relative to the tensioning piston 2. The main pivot axis 30, about which pivoting is intended to take place in a future case of use, is, however, shown in the figures and extends parallel to the first and second openings 6, 7 in the tensioning lever 1. Alternatively, the connection head 5 can also be cylindrical in shape, which means that, in the sectional plane shown in FIG. 1, the connection head 5 has a contour which is circular-arc-shaped at least in one area thereof, the connection head 5 being, however, implemented, for example, as a cylindrical element or after the fashion of a rod in the direction of the pivot axis 30. This has the advantage that the connection head 5 inserted in the reception opening will, due to its shape, predetermine a pivot axis 30 about which the tensioning lever 1 can be pivoted relative to the tensioning piston 2.

The joint bearing 3 and the joint cap 25 are shaped in accordance with the abovementioned embodiments of the connection head 5, i.e., the joint bearing 3 and the joint cap 25 may be spherical or they may have the shape of a cylinder or a rod. In the case of a rod-shaped embodiment, the joint cap 25 may be implemented, for example, after the fashion of a laterally open joint casing.

The connection socket 24 encloses the connection head 5 up to and beyond an equatorial plane 36. The equatorial plane 36 is the plane that is intersected at right angles by the longitudinal axis 22 of the tensioning piston 2 and in which the largest opening width of the circular or cylindrical cross-section of the connection head lies. It follows that the connection head 5 is encompassed in its area having the largest opening width as well as in a second area lying between said area having the largest opening width and the damper housing 11.

The mode of operation of the tensioning device will now be described.

The spring 10 of the tensioning piston 2 applies pressure in the direction of the longitudinal axis 22 of the tensioning piston 2. In so doing, it rests on the first spring carrier 18 and on the second spring carrier 20. This has the effect that the damper piston 13 is extended from the damper housing 11. The damper plate 12 is fixedly connected to the damper piston 13 and is displaced together therewith in the interior of the damper housing 11 along the longitudinal axis 22 towards the second end portion 19. In the course of this process, the first damping chamber 15 becomes smaller and the second damping chamber 16 becomes larger. Damping fluid contained in the first damping chamber 15 is pressed through and/or around the damper plate 12 into the second damping chamber 16. In order to allow the damper piston 13 to be extended in this way, the second spring carrier 20 is provided on an area of the damper piston 13 located outside of the damper housing 11. Due to the extension of the damper piston 13, the overall length of the tensioning piston 2 is increased along the longitudinal axis 22. On the piston end 23 of the damper piston 13 located outside of the damper housing 11, the connection head 5 is provided. The connection head 5 is circular in cross-section. The connection head 5 comprises the joint bearing 3 and the joint cap 25, which is attached to the joint bearing 3. The joint cap 25 has an inner contour corresponding essentially to the circular outer contour or the circular cross-section of the joint bearing 3.

When the joint cap 25 is pushed onto the joint bearing 3, a snap-on connection will therefore be obtained, i.e., the joint bearing 3 will be slightly expanded so as to receive the joint bearing 3 therein. The joint cap 25 thus has elastic characteristics and holds the connection socket 24. The joint cap 25 is pushed onto the joint bearing 3 along the longitudinal axis 22 in the direction of the first end portion 17, i.e., opposite to the direction in which the tensioning piston 2 is effective.

The joint cap 25 has a circular or a bell-shaped outer contour or a circular or bell-shaped cross-section. The inner contour of the reception opening 4 has an outer contour which corresponds essentially to the outer contour of the joint cap 25. This configuration results in the formation of an undercut in the reception opening 4, and this has the effect that, when the joint cap 25 is inserted into the reception opening 4, a firm connection will be established, i.e., a connection which does not release of its own accord or during operation. The connection is established after the fashion of a snap-on connection, i.e., when the joint cap 25 is inserted into the reception opening 4, the tensioning lever 1 will be elastically deformed and a force has to be applied. Once the joint cap 25 has been inserted into the joint opening 4 up to its end position, the joint cap 25 is captively held by means of an undercut defined by the reception opening 4 and the at least one boundary area 35. Alternatively, the joint cap 25 may be elastic and undergo elastic deformation when it is being inserted in the reception opening 4.

Alternatively, it is also possible to insert the connection head 5 laterally into the tensioning lever 1. In this case, the tensioning lever 1 is provided with a lateral opening which extending along the pivot axis 30. The spherical or cylindrical connection head 5 is thus laterally inserted into the reception opening 4 of the tensioning lever 1 along the pivot axis 30. The connection head 5 is thus secured, by means of the at least one boundary area 35, against removal in the direction of the longitudinal axis 22 of the tensioning piston 2. In the case of this embodiment, the reception opening 4 may either extend fully through the tensioning lever 1 along the axis 30 and be open towards both side walls of the tensioning lever 1 or it may be open towards only one side of the tensioning lever 1.

When the tensioning device is being assembled, the tensioning piston 2 is fitted together in a first step. To this end, the spring 10 is slid onto the damper housing 10, and the damper piston 13 as well as the damper plate 12 are inserted into the damper housing 10. When the damper housing 10 has been closed, the joint cap 25 is attached to the joint bearing 3. In the course of this process, an end portion of the spring 10 rests on the second spring carrier 20 formed on the joint cap 25. All the elements of the tensioning piston 2 are thus fixed relative to one another and the tensioning piston 2 can thus be transported more easily. For completing the tensioning device, the tensioning lever 1 is attached to the connection head 5. The whole assembly of the tensioning device is executed without making use of any tools. The connection between the tensioning lever 1 and the tensioning piston 2 is only maintained through positive locking, and it is thus possible to establish a connection without making use of any tools.

For utilizing the tensioning device in an internal combustion engine, a tensioning pulley is mounted at the second opening 7 of the tensioning lever 1. The tensioning device can then be mounted in a traction drive. The connection between the tensioning lever and the crankcase or a mounting structure is established at the first opening 6 such that pivoting about said first opening 6 is possible. The tensioning device can be used in connection with a chain drive as well as a belt drive. Such traction drives normally comprise at least one endless drive, e.g., a chain, a belt, etc., at least two drive wheels arranged in an area enclosed by the drive, and a tensioning device of the type described.

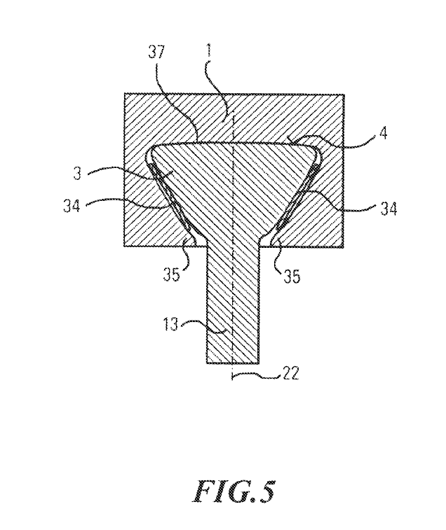

Additional embodiments of the tensioning device will be explained with reference to FIGS. 4, 5 and 6. Only the essential differences in comparison with the preceding embodiment will be described hereinbelow. Hence, identical reference numerals will be used for identical components and for components producing the same effect and the preceding description will be referred to accordingly.

FIG. 4 shows a further embodiment of the tensioning device according to the present invention. The schematically shown tensioning lever 1 is provided with a joint opening 4. The damper piston 13 has formed thereon a connection head 5. A joint cap 25 extends around the connection head 5 and encloses the same. The joint cap 25 is here provided with locking jaws 28 engaging complementary detent openings 29 formed on the tensioning lever 1. The detent openings 29 define an undercut and guarantee thus that the joint socket 25 is captively held in the tensioning lever 1.

For assembling the tensioning device of this embodiment, the joint bearing 3 is inserted into the joint cap 25. In the course of this process, the joint cap 25 is elastically expanded, said joint cap 25 reassuming its original shape after having the joint head 3 received therein. The joint cap 25 and the joint head 3 thus constitute a snap-on connection, the inner contour of the joint cap 25 defining an undercut by means of which the joint bearing 3 is held in the joint cap 25. The thus interconnected joint cap 25 and joint bearing 3 are now inserted into the reception opening 4 of the tensioning lever 1. This has the effect that the outer contour of the joint cap 25 comes into contact with the inner contour of the reception opening 4 at least in certain areas thereof. The tensioning lever 1 is elastically expanded when the joint cap 25 and the joint head 3 are inserted therein. Once the joint cap 25 and the joint head 3 have been inserted in the reception opening 4, the tensioning lever 1 reassumes its original shape, or remains elastically expanded to a minor extent so as to exert a holding force. The detent openings 29, which are implemented as a part of the joint opening 4, define at least one undercut which is engaged by the locking jaws 28 of the joint cap 25 or where said locking jaws 28 snap in place, i.e., a snap-on connection is formed by means of this configuration. The joint cap 25 received in the reception opening 4 can now no longer be elastically expanded by the tensioning lever 1 abutting on the outer contour of the joint cap 25, and this means that the joint head 3 is captively held.

In this embodiment, a pivotal movement between the tensioning lever 1 and the tensioning piston 2 is accomplished by the pivotable joint connection between the joint cap 25 and the joint bearing 3. The joint cap 25 of this embodiment is not provided with a second spring carrier 20 of the type shown in the first embodiment. In the present embodiment, the spring 10, however, rests directly on the tensioning lever 1. Such a structural design, i.e., without a second spring carrier 20 and with a spring 10 that rests directly on the tensioning lever 1, could also be used for the embodiment depicted in FIG. 1.

Another embodiment of the tensioning device according to the present invention is shown in FIG. 5. The joint connection between the tensioning lever 1 and the tensioning piston 2 has here the character of a dovetail connection. The damper piston 13 has attached thereto or formed thereon a connection head 5 with a dovetail-shaped cross-section. The dovetail-shaped connection head 3 has here a convex outer contour 37 extending substantially at right angles to the longitudinal axis 22. Along this outer contour 37, the dovetail-shaped cross-section can be pivoted in the reception opening 4. The connection socket 24 has an inner contour which is adapted to the dovetail-shaped connection head 3 so as to accommodate the same. In particular, the inner contour of the connection socket 24 is concave in an area that is in contact with the convex outer contour 37. The reception opening 4 is slightly larger than the dovetail-shaped connection head 5 so as to allow pivoting of said connection head 5 within the reception opening 4. The pivot axis is positioned at the centre of a circle defined by the preferably circular-arc-shaped convex outer contour 37. In correspondence with the above-shown embodiments, the reception opening 4 has in one area thereof an opening width that is larger than the opening width in a second area, i.e., an undercut is defined within the reception opening 4, which guarantees that the connection head 5 is captively held. In the embodiment shown, the reception opening 4 is shaped such that a non-destructive removal of the connection head 3 in the direction of the longitudinal axis 22 of the tensioning piston 2 is not possible.

For inserting the dovetail-shaped connection head 5 into the reception opening 4 of the tensioning lever 1, the tensioning lever 1 is provided with an insertion opening which extends in the direction of the pivot axis 30, said insertion opening extending preferably through the whole tensioning lever 1. The joint head 3 is thus inserted into the tensioning lever 1 through a lateral opening of said tensioning lever 1 in the direction of the pivot axis 30. Instead of a dovetail-shaped cross-section, the joint head 3 may alternatively also have, for example, a T-shaped cross-section. Also in this case, the joint head 3 is inserted through a lateral opening of the tensioning lever 1.

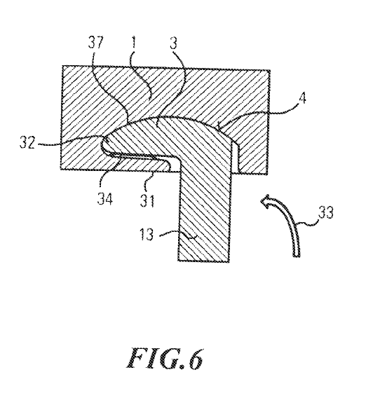

A further embodiment of a tensioning device is shown in FIG. 6. The connection head 5 according to this embodiment is L-shaped or hook-shaped. A crescent-shaped or sickle-shaped connection head 5 may be used as well. A convex outer contour 37 of the connection head 5 allows pivoting within the reception opening 4. The reception opening 4 of the tensioning lever 1 has a suitable shape for receiving the connection head 5 therein. In particular, a concave contour is provided in the area which is in contact with the convex outer contour 37. The reception opening 4 is slightly larger than the connection head 5 so as to allow pivoting of said connection head 5 within the reception opening 4. The pivot axis is located at the centre of a circle defined by the preferably circular-arc-shaped convex outer contour 37. A tongue-shaped portion 31 of the tensioning lever 1 is formed such that the connection head 5 can be pivotably inserted into the reception opening 4, i.e., for inserting the L-shaped connection head 5, a top end portion 32 is first inserted into the joint opening 4, and the joint head 3 is then, together with the adjoining damper piston 13, pivotably inserted into the reception opening 4 along a curvature 33. In the course of this process, the convex outer contour 37 slides along the connection socket 24. Alternatively, the tensioning lever 1 may also have a transverse opening extending along the pivot axis, whereby the connection head 5 can be inserted laterally along the pivot axis. Between an area of the connection head 5 and the tensioning lever 1, a retaining element 34 can be inserted or provided. The retaining element 34 can be provided on the connection head 5 as a separate component as well as in the form of a component that is formed integrally therewith. The retaining element 34 serves to lock the connection head 5 in position in the reception opening 4, or it serves as a captive fastener. The captive fastener 34 can be configured such that it causes the connection head 5 and the tensioning lever 1 to be in a biased condition. The retaining element 34 can be used in all the embodiments or variants presented.

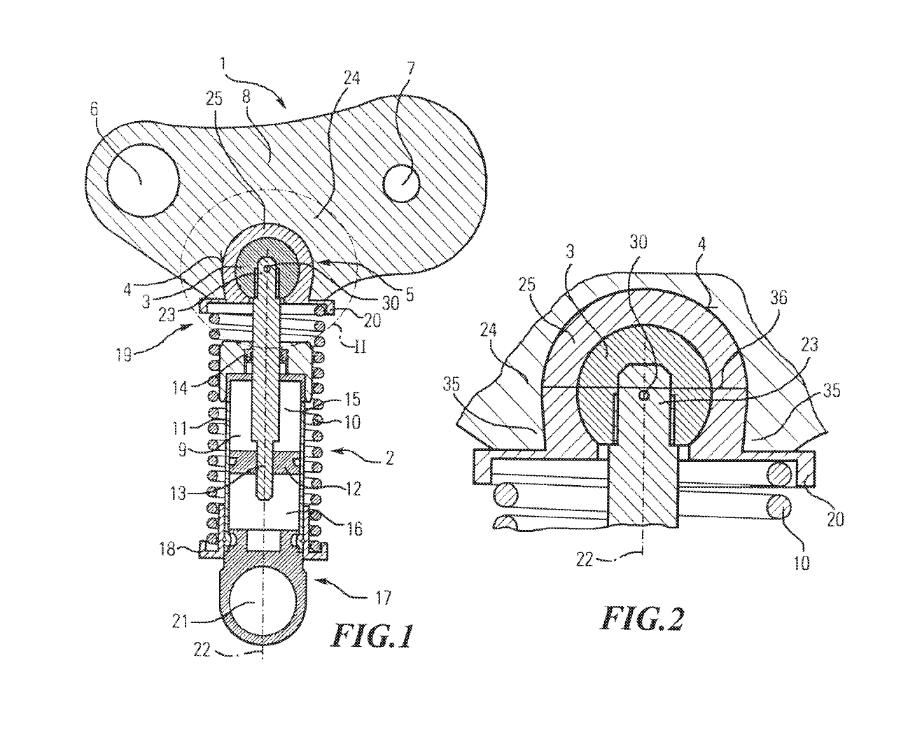

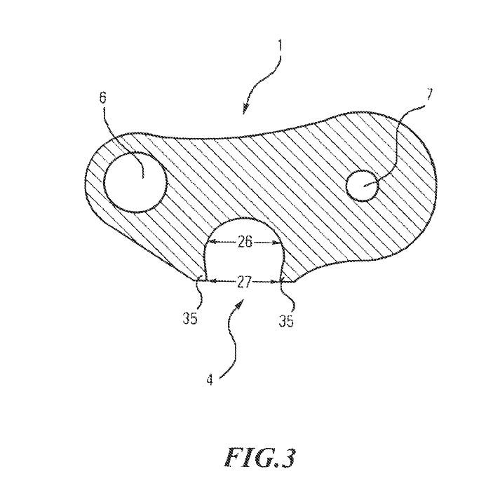

A feature which all the above presented embodiments have in common is that such a connection may also be provided on the first end portion 17 (not shown in the figures). The second connection head may be configured such that it corresponds to the first connection head 5, as shown in FIGS. 1 to 6, i.e., it may e.g. also consist of a joint bearing and a joint cap. In addition, it is possible to provide only a joint bearing which is in contact with an additional element and defines a joint connection therewith. The connection socket is defined by an element other than the tensioning lever, e.g. by the engine block or a mounting structure. It is therefore possible to protect exclusively such a connection provided only on the first end portion 17 of the tensioning element. This means that the tensioning device may include a connection head only at the first end portion 17, i.e., the connection between the tensioning lever and the tensioning piston is established in a hitherto known manner, for example, by means of a bolt.

The second connection head 5 can be in contact with a second connection socket or it may be inserted therein. The connection head may have all the above-presented shapes, and it may be inserted in a second reception opening. The second connection socket may be formed, for example, on a mounting structure or on the engine block. In correspondence with the first reception opening 4, the second reception opening may be provided with boundary areas encompassing the connection head such that the latter will not be able to release of its own accord. All the statements made hereinbefore with respect to the connection between the tensioning lever 1 and the tensioning piston 2 by means of the connection head 5 are also applicable to the connection between the second connection head and the second reception opening in the vicinity of the first end portion 17, the only difference being that this connection is established at the first end portion 17 and that the component to be connected is not a tensioning lever 1. All the operating principles or presented embodiments are, however, also applicable to this connection. According to the present invention, it is possible to provide such connection heads on the first end portion 17 as well as on the second end portion 19, and it is also possible to provide only a single connection head of this type on only one of the two end portions 17, 19.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A tensioning device for an endless drive, comprising:
a tensioning lever including a connection socket defining a reception opening;
a tensioning piston including a connection head; and
a pivotable joint connection implemented between the tensioning lever and the tensioning piston by means of the connection head,
wherein by means of the connection socket and at least one boundary area formed thereon, the connection head is, at least in certain areas thereof, encompassed in the reception opening in such a way that the connection head is secured against separation from the connection socket in a direction opposite to the direction of operation of the tensioning piston.

2. A tensioning device according to claim 1, wherein the direction of operation of the tensioning piston extends along a longitudinal axis of the tensioning piston, and wherein the boundary area reduces the width of a cross-section the reception opening along the longitudinal axis and defines an undercut in which the connection head is accommodated, at least with certain areas thereof.

3. A tensioning device according to claim 1, wherein the tensioning lever is provided with fastening means for pivotable fastening to a mounting structure.

4. A tensioning device according claim 1, wherein the joint connection comprises a joint cap and a joint bearing with a cross-section that is substantially circular in the direction of the longitudinal axis of the tensioning piston.

5. A tensioning device according to claim 4, wherein the tensioning piston comprises a spring resting on the joint cap with one end portion thereof.

6. A tensioning device according to claim 5, wherein the reception opening encompasses the substantially circular cross-section of the joint bearing at least up to and beyond an equatorial plane.

7. A tensioning device according to claim 2, wherein the connection head is inserted in the reception opening in the direction of the longitudinal axis of the tensioning piston.

8. A tensioning device according to claim 7, wherein, at least in the area of the connection socket, the tensioning lever is elastically deformable.

9. A tensioning device according to claim 2, wherein the connection head has a dovetail-shaped cross-section in the direction of the longitudinal axis of the tensioning piston.

10. A tensioning device according to claim 2, wherein the connection head has an L-shaped cross-section in the direction of the longitudinal axis of the tensioning piston, a tongue defined through said L-shaped cross-section engaging the reception opening, at least in certain areas thereof, and engaging behind the boundary area.

11. A tensioning device according to claim 1, wherein a retaining element is positioned between the tensioning lever and the connection head, said retaining element causing the tensioning lever and the connection head to be in a biased condition.

12. A tensioning device according to claim 11, wherein the retaining element is formed integrally with the connection head.

13. A tensioning device according to claim 4, wherein a second joint bearing is formed on an end portion of the tensioning piston facing away from the connection head.

14. A tensioning device according to claim 13, wherein the second joint bearing is configured such that the second joint bearing and a mating joint component define a pivotable joint.

15. A traction drive for an internal combustion engine, comprising an endless drive, at least two drive wheels arranged in an area enclosed by the endless drive, and a tensioning device according to claim 1.
